(19) United States
(12) Patent Application Publication
(10) Pub. No.: US 2018/0146734 A1
(43) Pub. Date: May 31, 2018

(54) MODULAR HATS AND HEADWEAR

(71) Applicant: Caitlin Kelly, New York, NY (US)

(72) Inventor: Caitlin Kelly, New York, NY (US)

(21) Appl. No.: 15/364,788

(22) Filed: Nov. 30, 2016

(51) Int. Cl. A42B 1/20; A42B 1/02; A42B 1/06; A42B 1/24; A42B 7/00; A42B 1/00; H02S 20/30; H02S 99/00; H02S 40/38

(52) U.S. Cl. CPC A42B 1/206; A42B 1/02; A42B 1/064; A42B 1/205; H02S 40/38; A42B 7/00; A42B 1/004; H02S 20/30; H02S 99/00; A42B 1/245

(57) ABSTRACT

A hat may include a crown, a brim or visor removably attached to the crown, and a strap looping the crown over the brim or visor.

### TECHNICAL FIELD

Generally, this disclosure relates to clothing. More particularly, this disclosure relates to hats and headwear.

### BACKGROUND

In this disclosure, where a document, an act, and/or an item of knowledge is referred to and/or discussed, then such reference and/or discussion is not an admission that the document, the act, and/or the item of knowledge and/or any combination thereof was at a priority date, publicly available, known to a public, part of common general knowledge, and/or otherwise constitutes any prior art under any applicable statutory provisions; and/or is known to be relevant to any attempt to solve any problem with which this disclosure may be concerned with. Further, nothing is disclaimed.

A hat generally cannot be customized based on a user need, while remaining sufficiently aesthetic. For example, a sunhat cannot be customized for a brim use, a visor use, a crown use, or a combinatory use, while remaining sufficiently aesthetic. Accordingly, there is a desire to address at least such drawbacks.

### SUMMARY

This disclosure may at least partially address at least one of above inefficiencies. However, this disclosure can prove useful to other technical areas. Therefore, various claims recited below should not be construed as necessarily limited to addressing any of the above inefficiencies.

In an embodiment, a method comprises removably attaching a crown to a C-shaped brim and tying a strap in an adjustable loop such that the loop loops the crown and the strap extends along the C-shaped brim.

In an embodiment, a method comprises removably attaching a crown to a visor and tying a strap in an adjustable loop such that the loop loops the crown and the strap extends over the visor.

In an embodiment, a method comprises removably attaching a crown to a C-shaped brim, attaching a strap to the C-shaped brim, and selectively adjusting the C-shaped brim via the strap.

In an embodiment, a kit comprises a crown, a C-shaped brim configured for attachment to the crown in a first manner, a visor configured for attachment to the crown in a second manner, and a strap.

This disclosure may be embodied in various forms illustrated in a set of accompanying illustrative drawings. Note that variations are contemplated as being a part of this disclosure, limited only by a scope of various claims recited below.

### BRIEF DESCRIPTION OF DRAWINGS

The set of accompanying illustrative drawings shows various example embodiments of this disclosure. Such drawings are not to be construed as necessarily limiting this disclosure. Like numbers and/or similar numbering scheme can refer to like and/or similar elements throughout.

FIG. 1 shows an embodiment of a crown according to this disclosure.

FIGS. 2A and 2B show an embodiment of a brim according to this disclosure.

FIGS. 3A and 3B show an embodiment of a visor according to this disclosure.

FIGS. 4A and 4B show various embodiments of a brim according to this disclosure.

FIG. 5 shows an embodiment of a brim and a strap according to this disclosure.

FIG. 6 shows an embodiment of a method of attachment of a crown to a brim according to this disclosure.

FIG. 7 shows an embodiment of a hat having a crown attached to a brim according to this disclosure.

FIG. 8 shows an embodiment of a strap looped about a crown of a hat while extending along a brim of the hat according to this disclosure.

FIGS. 9A and 9B show an embodiment of a method of attaching a crown to a visor according to this disclosure.

### DETAILED DESCRIPTION OF PREFERRED EMBODIMENTS

This disclosure is now described more fully with reference to the set of accompanying illustrative drawings, in which example embodiments of this disclosure are shown. This disclosure may, however, be embodied in many different forms and should not be construed as necessarily being limited to the example embodiments disclosed herein. Rather, the example embodiments are provided so that this disclosure is thorough and complete, and fully conveys various concepts of this disclosure to those skilled in a relevant art.

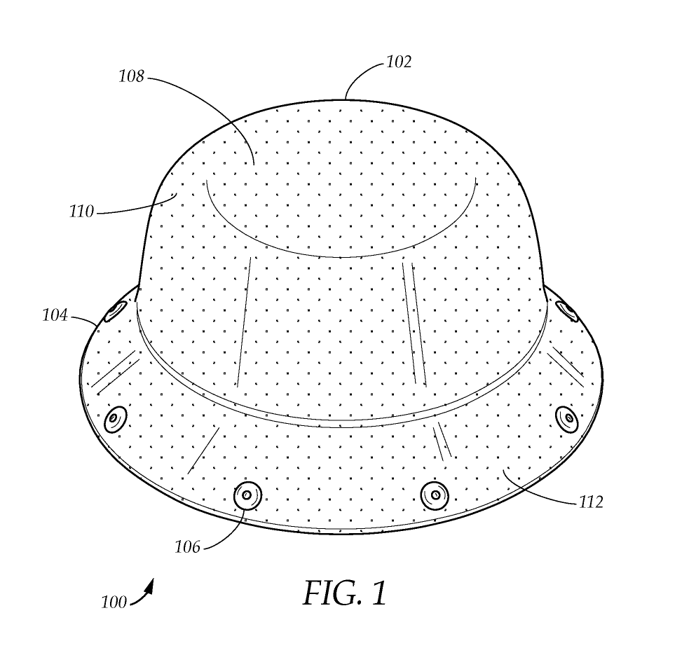

FIG. 1 shows an embodiment of a crown according to this disclosure. A crown 100 includes a bowl 102 and a skirt 104. The skirt 104 depends from the bowl 102, whether directly or indirectly. The bowl 102 can depict any pattern thereon, such as on any external or internal surface thereof. The skirt 104 can depict any pattern thereon, such as on any external or internal surface. The bowl 102 and the skirt 104 are unitary, such as a single piece, whether transparent, translucent, or opaque, but can be an assembly, such as via multiple pieces, whether from a same material or different materials, whether transparent, translucent, or opaque. In some embodiments, the bowl 102 is rain-proof.

The bowl 102 includes a base 108 and a wall 110. The wall 110 extends from the base 108 such that an internal cavity is defined thereby. The internal cavity is sized to fit, whether snugly, or loosely, a head of a user, whether male or female, including a pony tail. The internal cavity can be sized such that an accessory can be worn on the head, such as a headphone, a hair clip, a headband, or others. The wall 110 may include an elastic member, such as a rubber band, to enhance fitting. The elastic member is internal or external and can be user adjustable. Although the base 108 and the wall 110 are solid, in some embodiments, the base 108 or the wall 110 can be perforated. Each of the base 108 and the wall 110 is unitary, such as a single piece, whether transparent, translucent, or opaque, but can be an assembly, such as via multiple pieces, whether from a same material, whether transparent, translucent, or opaque, or different material, whether transparent, translucent, or opaque. Each of the base 108 and the wall 110 is flexible, but can be rigid.

The skirt 104 is defined via a wall 112, whether transparent, translucent, or opaque. The skirt 104 non-perpendicularly extends from the bowl 102, such as at a forty five degree angle, although other non-perpendicular angles or perpendicular extension is possible. Such extension enables the skirt 104 to shield the head, such as from rain, snow, sun, or others. Although the wall 112 is solid, in some embodiments, the wall 112 is perforated. The wall 112 can be rigid or flexible.

The skirt 104 includes a plurality of snap fasteners 106 positioned along a longitudinal length of the wall 112. The snap fasteners 106 are equidistant from each other, although non-equidistant positioning is possible. Also, although the snap fasteners 106 extend in a uniform manner equidistant from the wall 110, other manners of extension are possible, such as zigzag, pulse, sinusoidal, or others. Alternative or additional to the snap fasteners 106, the wall 112 may include any type of attachment technology. For example, the wall 112 may include a magnet, a bolt, a nut, a button, an opening/slit, a zipper, a wire, a ribbon, a hook-and-loop fastener, a thread, a hook, a tape, a screw, a nail, a belt, a chain, a staple, an adhesive, a rubber band, a chain, a clip, or others.

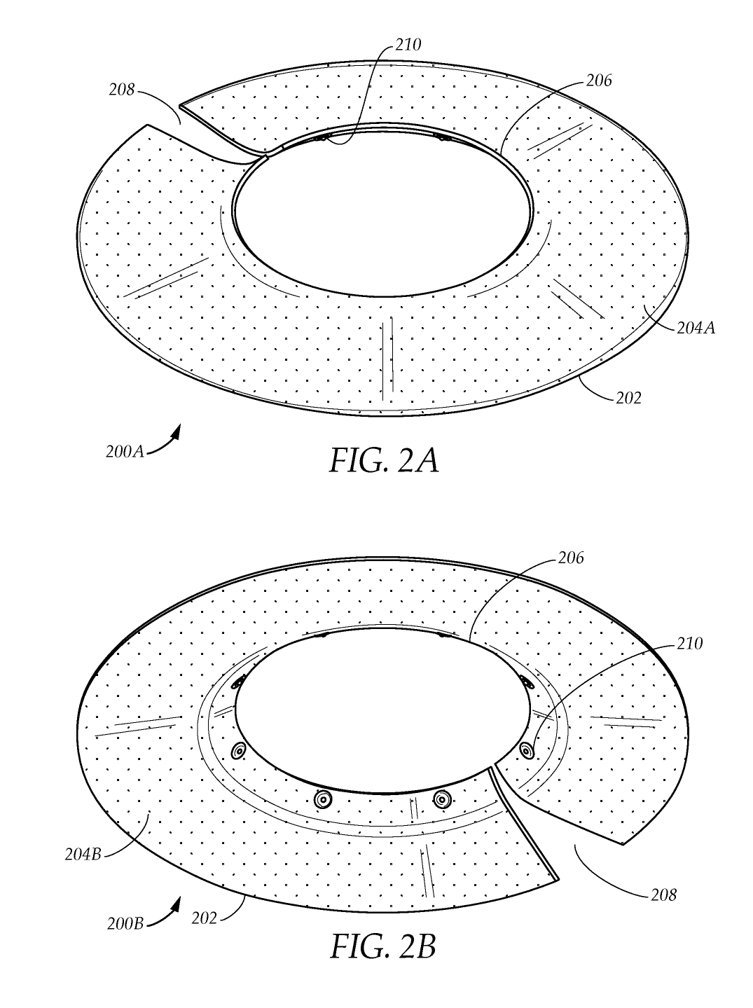

FIGS. 2A and 2B show an embodiment of a brim according to this disclosure. A brim 200 is shown as a top view in FIG. 2A as a brim 200A and a bottom view in FIG. 2B as a brim 200B. The brim 200 is generally circular, such as C-shaped, but other shapes are possible, such as ovoid, elliptical, triangular, square, rectangular, pentagonal, octagonal, hexagonal, or any other polygonal shape, whether with a sharp or rounded corner, whether solid or perforated, whether transparent, translucent, or opaque, whether rigid or flexible. The brim 200 is unitary, such as a single piece, but can be an assembly, such as via multiple pieces, whether from a same material or different material.

The brim 200 includes an outer edge portion 202, an upper side 204A, a lower side 204B, an inner edge portion 206, a gap 208, and a plurality of snap fasteners 210 positioned along a longitudinal length of the brim 200. The brim 200 may include an elastic member, such as a rubber band, to enhance fitting. The elastic member is internal or external and can be user adjustable. In some embodiments, the brim 200 is rain-proof. The brim 200 can depict any pattern thereon, such as on any external or internal surface thereof. Note that the crown 100 and the brim 200 share or have a same pattern depicted thereon, although in other embodiments, the crown 100 and the brim 200 do not share or do not have a same pattern depicted thereon, whether via a same recordation technique or different materials.

The outer edge portion 202 extends in a generally circular pattern, although other extension patterns are possible, such as zigzag, pulse, sinusoidal, or others. The inner edge portion 206 extends in a generally circular pattern, although other extension patterns are possible, such as zigzag, pulse, sinusoidal, or others. The inner edge portion 206 can be angled with respect to at least one of the upper side 204A or the lower side 204B. For example, such angling can be acute, obtuse, perpendicular, or none at all, such as via being rectilinear. For example, such angle can range between five degrees and eighty degrees, such as when the inner edge portion 206 is angled to appear as an inclined wall with respect to the side 204A.

The upper side 204A spans between the outer edge portion 202 and the inner edge portion 206. The lower side 204B spans between the outer edge portion 202 and the inner edge portion 206. Although the upper side 204A and the lower side 204B are different pieces of the brim 200, in some embodiments, the upper side 204A and the lower side 204B are a single piece of the brim 200, yet opposing sides 204A, 204B of the brim 200. Each of the upper side 204A and the lower side 204B can unitary, such as a single piece, or an assembly, such as via multiple pieces. The brim 200 includes a pair of adjacent end portions, which define the gap 208, which can be of any size or shape, such as a circle, an ovoid, an ellipse, a triangle, a rectangle, a square, a pentagon, an octagon, a hexagon, or any other polygonal shape, whether with a sharp or rounded corner. In some embodiments, the brim 200 lacks the 208 such that the brim 200 is in a fully closed shape.

The snap fasteners 210 are equidistant from each other, although non-equidistant positioning is possible. Also, although the snap fasteners 210 extend in a uniform manner equidistant from the inner edge portion 206, other manners of extension are possible, such as zigzag, pulse, sinusoidal, or others. Alternative or additional to the snap fasteners 210, the brim 200 may include any type of attachment technology. For example, the brim 200 may include a magnet, a bolt, a nut, a button, an opening/slit, a zipper, a wire, a ribbon, a hook-and-loop fastener, a thread, a hook, a tape, a screw, a nail, a staple, an adhesive, a rubber band, a chain, a clip, or others. For example, the snap fasteners 106 and the snap fasteners 210 may engage, interlock, mate, or otherwise attach/couple with each other to selectively secure the brim 200 to the crown 100 as the inner edge portion 206 overlays the wall 112, whether the inner edge portion 206 contacts the wall 112 or not, such as via a gap existing therebetween. In some embodiments, the upper side 204A includes a plurality of snap fasteners, such as the snap fasteners 210, or any other attachment technology, including those disclosed herein.

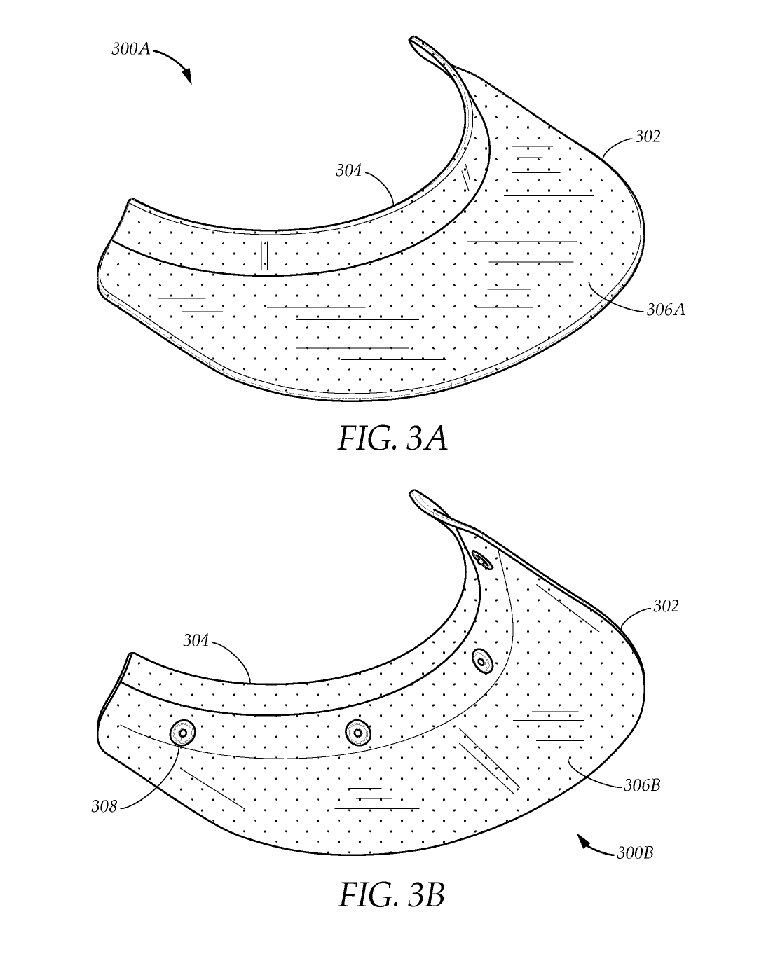

FIGS. 3A and 3B show an embodiment of a visor according to this disclosure. A visor 300 is shown as a top view in FIG. 3A as a visor 300A and a bottom view in FIG. 3B as a visor 300B. The visor 300 includes an outer edge portion 302, a wall 304, a base 306 having an upper side 306A and a lower side 306B, and a plurality of snap fasteners 308 positioned along the wall 304. The visor 300 may include an elastic member, such as a rubber band, to enhance fitting, such as via the wall 304. The elastic member is internal or external and can be user adjustable. In some embodiments, the brim 300 is rain-proof. The visor 300 can depict any pattern thereon, such as on any external or internal surface thereof. Note that the crown 100 and the visor 300 share or have a same pattern depicted thereon, although in other embodiments, the crown 100 and the visor 300 do not share or do not have a same pattern depicted thereon, whether via a same recordation technique or different materials. Note that the visor 300 can be worn alone.

The outer edge portion 302 extends in a generally straight pattern, although other extension patterns are possible, such as zigzag, pulse, sinusoidal, or others. The outer edge portion 302 is distal to the wall 304.

The wall 304 extends from the base 306, whether in a perpendicular or non-perpendicular manner, such as acute or obtuse, such as at a sixty degree angle. The wall 304 can be solid or perforated, rigid or flexible, unitary, such as a single piece, or an assembly, such as via multiple pieces, whether transparent, opaque, or translucent.

The base 306 is generally crescent-shaped, but other shapes are possible, such as circular, ovoid, elliptical, triangular, square, rectangular, pentagonal, octagonal, hexagonal, or any other polygonal shape, whether with a sharp or rounded corner, whether solid or perforated, whether transparent, translucent, or opaque, whether rigid or flexible. The base 306 is unitary, such as a single piece, but can be an assembly, such as via multiple pieces, whether from a same material or different material.

The snap fasteners 308 are equidistant from each other, although non-equidistant positioning is possible. Also, although the snap fasteners 308 extend in a uniform manner equidistant from an upper edge portion of the wall 304, other manners of extension are possible, such as zigzag, pulse, sinusoidal, or others. Alternative or additional to the snap fasteners 308, the visor 300 may include any type of attachment technology. For example, the visor 300 may include a magnet, a bolt, a nut, a button, an opening/slit, a zipper, a wire, a ribbon, a hook-and-loop fastener, a thread, a hook, a tape, a screw, a nail, a staple, an adhesive, a rubber band, a chain, a clip, or others. For example, the snap fasteners 106 and the snap fasteners 308 may engage, interlock, mate, or otherwise attach/couple with each other to selectively secure the visor 300 to the crown 100 as the wall 304 or the base 306 overlays the wall 112, whether the wall 304 or the base 306 contacts the wall 112 or not, such as via a gap existing therebetween.

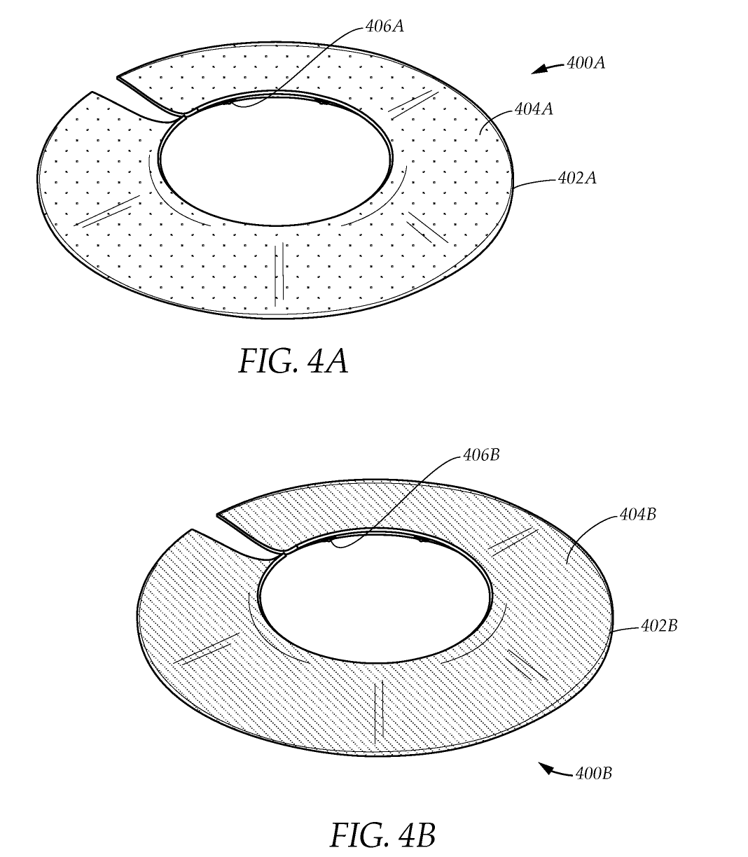

FIGS. 4A and 4B show various embodiments of a brim according to this disclosure. A brim 400A includes an outer edge portion 402A, a side 404A, and a plurality of snap fasteners 406A. Likewise, a brim 400B includes an outer edge portion 402B, a side 404B, and a plurality of snap fasteners 406B. Each of the brims 400A and 400B is similar to the brim 200 and to each other, although any brim dissimilarities in shape, size, material, properties, structure, or function may exist. For example, the brim 400A may be configured for a sunny climate and the brim 400B is configured for a rainy climate. For example, the brim 400A may have a first shape/size/structure/material and the brim 400B may have a second shape/size/structure/material different from the first shape/size/structure/material. Note that same applies to visor 300.

However, as shown in FIGS. 4A and 4B, the brim 400A and the brim 400B differ in that the side 404A has one pattern depicted thereon and the side 404B has another, different pattern depicted thereon, whether of same or different pattern recordation technique, whether same or different material. Therefore, the brim 400A and the brim 400B can be interchangeably or modularly used, such as for different occasions or moods of the user.

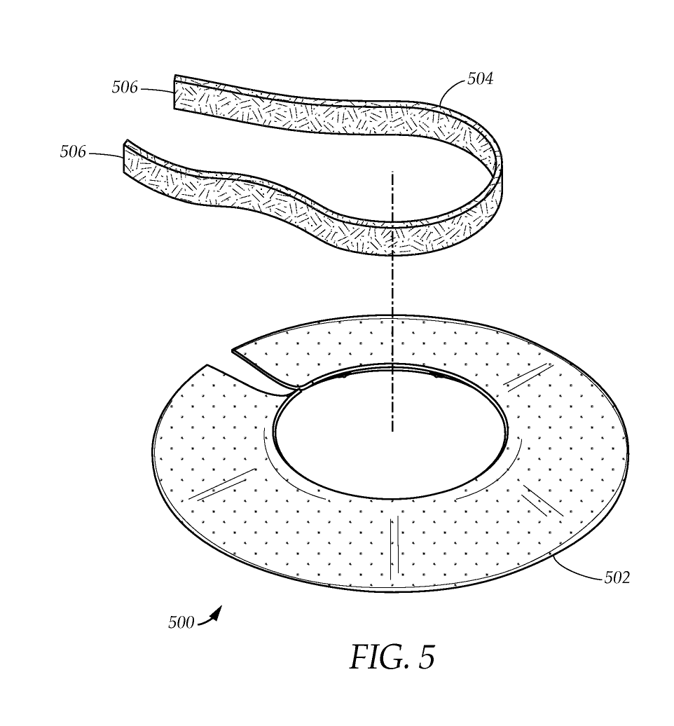

FIG. 5 shows an embodiment of a brim and a strap according to this disclosure. A kit 500 includes a brim 502 and a strap 504. In some embodiments, the kit 500 may include the crown 100 or the visor 300. The brim 502 can be similar to the brim 200, 400A, 400B, or another brim configuration. The strap 504 includes a pair of end portions 506. The strap 504 is flexible and can be elastic or stretchable. The strap 504 is sufficiently long to extend, such as via enclosing or circumnavigating, about the crown 100. The strap 504 can include a ribbon, a band, a belt, or a chain. For example, the strap 504 can include fabric, leather, plastic, rubber, metal, wood, precious stone, a buckle, a lock, or others. The strap 504 can be rain-proof. The strap 504 can be transparent, translucent, or opaque. For example, the kit 500 may include crown 100, the brim 502 configured for attachment to the crown 100 in a first manner, which may be removably, the visor 300 configured for attachment to the crown 100 in a second manner, which may be removably, the strap 504, and a set of instructions explaining how to use the kit 500, where the set of instructions can be memorialized or recorded on a paper, an electronic file, or another storage medium. For example, the first manner, such as fastening, and the second manner, such as fastening, are a single manner, whether of a same type or different type. For example, the first manner, such as interlocking, and the second manner, such as mating are different manners. For example, the strap 504 is configured for attachment to the brim 502 removably, such as via fastening, interlocking, mating, clipping, adhering, magnetizing, or any other methods, including those disclosed herein. For example, the strap 504 can be configured for adjustment of the brim 502 selectively when attached thereto, such as via tightening the strap 504 or loosening the strap 504. For example, the strap 504 can be configured for attachment to the visor 300 removably. In some embodiments, the pair of end portions 506 can be secured to each other, whether removably or not, such as via fastening, mating, interlocking, adhering, magnetizing, or any other attached technique, including those disclosed herein. In some embodiments, the strap 504 includes an attachment interface, whether between the end portions 506 or on the end portions 506, such as a magnet, a bolt, a nut, a button, an opening/slit, a zipper, a wire, a ribbon, a hook-and-loop fastener, a thread, a hook, a tape, a screw, a nail, a belt, a chain, a staple, an adhesive, a rubber band, a chain, a clip, or others.

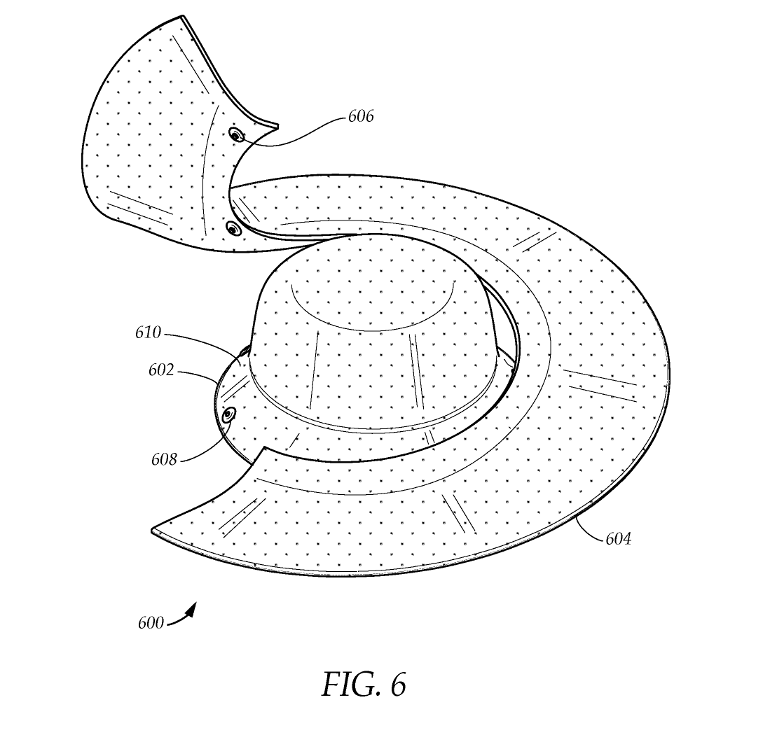

FIG. 6 shows an embodiment of a method of attachment of a crown to a brim according to this disclosure. A method 600 includes accessing a crown 602 and a brim 604 and then attaching the crown 602 to the brim 604, such as removably. In particular, the crown 602 is similar to the crown 100. The brim 604 is similar to the brim 200. The crown 602 includes a plurality of snap fasteners 608 and a skirt 610 hosting the snap fasteners 608 similar to the crown 100. The snap fasteners 608 are similar to the snap fasteners 106. The skirt 610 is similar to the skirt 104. The brim 604 includes a plurality of snap fasteners 606 hosted similarly to the brim 200. The snap fasteners 606 are similar to the snap fasteners 210. Therefore, the crown 602 is attached to the brim 604 via the snap fasteners 608 engaging with the snap fasteners 606 such that an inner side of the brim 604 overlays the skirt 610, whether via contacting the skirt 610 or not, such as via a gap therebetween. Likewise, to detach the crown 602 from the brim 604, the snap fasteners 608 disengage with the snap fasteners 606, such as via an action of the user.

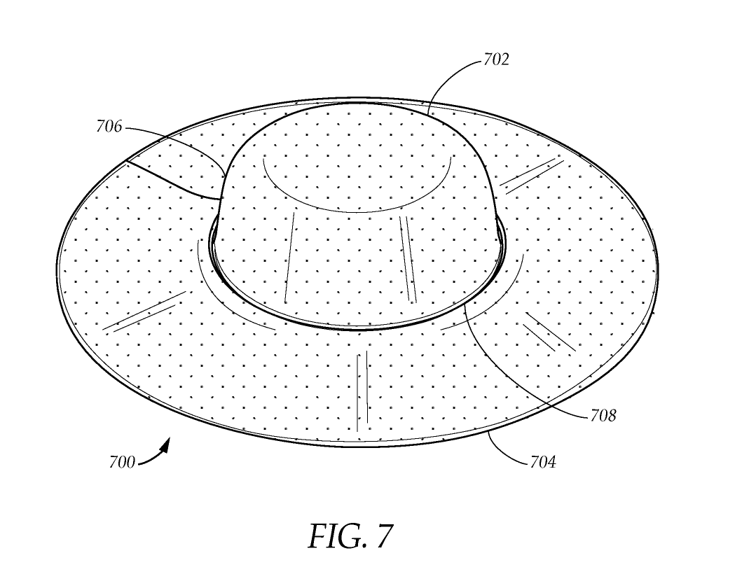

FIG. 7 shows an embodiment of a hat having a crown attached to a brim according to this disclosure. Upon conclusion of the method 600, a hat 700 is formed, where the hat 700 includes a crown 702 and a brim 704. The crown 702 includes a skirt 708, which is covered via the brim 704. The crown 702 and the brim 704 are selectively secured to each other, such as attached via the method 600. The crown 702 and the brim 704 can be selectively unsecured from each other, such as via reversing the method 600. Note that the brim 704 has a seam 706 positioned between a pair of ends thereof In some embodiments, the seam 706 is lacking and the brim 704 is fully closed shaped.

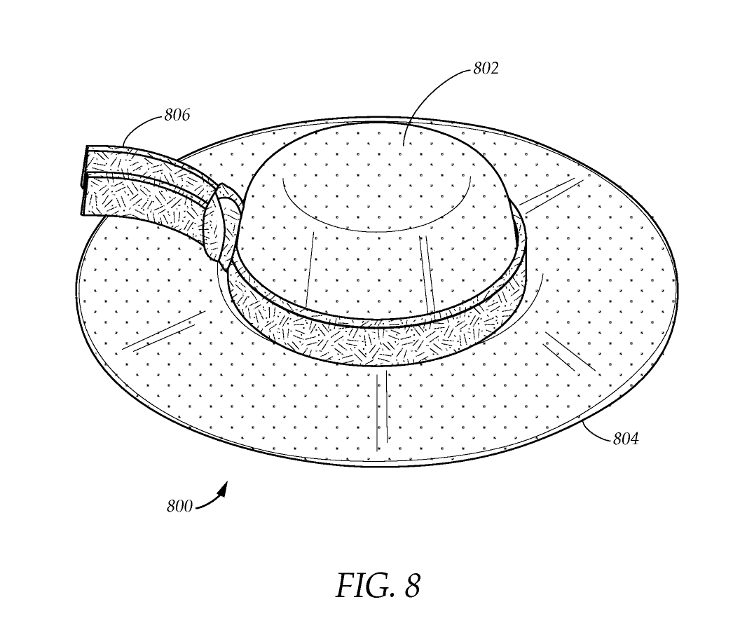

FIG. 8 shows an embodiment of a strap looped about a crown of a hat while extending along a brim of the hat according to this disclosure. A hat 800 can be formed based on the hat 700. The hat 800 includes a crown 802, a brim 804, and a strap 806. The crown 802 is similar to the crown 702. The brim 804 is similar to the brim 704. The strap 806 is similar to the strap 504. The strap 806 is extended or looped about the crown 802, such as via contacting the crown 802, and a pair of end portions of the strap 806 are tied about each other at least one time into a knot of any type. For example, the strap 806 can be tied in an adjustable loop such that the loop loops the crown 802 and the strap 806 extends along the brim 804. For example, as the brim 804 includes an inner edge portion, such as the inner edge portion 206, extending over the crown 802, the strap 806 can extend over the inner edge portion. For example, the strap 806 can contact the crown 802.

In some embodiments, a clip is used to secure the pair of end portions together, such as when the clip contacts the crown 802 in order to create a tight fit. For example, the clip may be U-shaped or C-shaped and the clip may include a pair of magnetized or otherwise attachable end portions. In some embodiments, the strap 806 can be selectively tightened or untightened to adjust a fit to the head of the user, such as via controlling a degree or extent of pulling the strap 806. In some embodiments, the strap 806 covers a seam area formed when the crown 802 is attached to the brim 804, where the seam area is positioned between the crown 802 and the brim 804 and extending above the skirt 708. In some embodiments, the pair of end portions can be positioned to cover or lay over the seam 706, although other positioning is possible. In some embodiments, the strap 806 can be secured to the crown 802 or the brim 804, such as via a magnet, a bolt, a nut, a button, an opening/slit, a zipper, a wire, a ribbon, a hook-and-loop fastener, a thread, a hook, a tape, a screw, a nail, a staple, an adhesive, a rubber band, a chain, a clip, or others, where at least one of the crown 802, the brim 804, or the strap 806 includes at least one such securing device. For example, the strap 806 can be attached to the brim 804 such that the brim 804 is adjustable via the strap 806 selectively, such as via tightening/pulling or untightening/loosening, which can be via knots or clips. For example, the strap 806 can be attached to the brim 804 removably. For example, the crown 802 can be attached to the brim 804 removably, the strap 806 can be attached to the brim 804 removably, and the brim 804 can be adjusted via the strap 806 selectively, such as via tightening or loosing of the strap 806. For example, as the brim 804 brim includes an inner edge portion, such as the inner edge portion 206, extending over the crown 802, the strap 806 can extend over the inner edge portion.

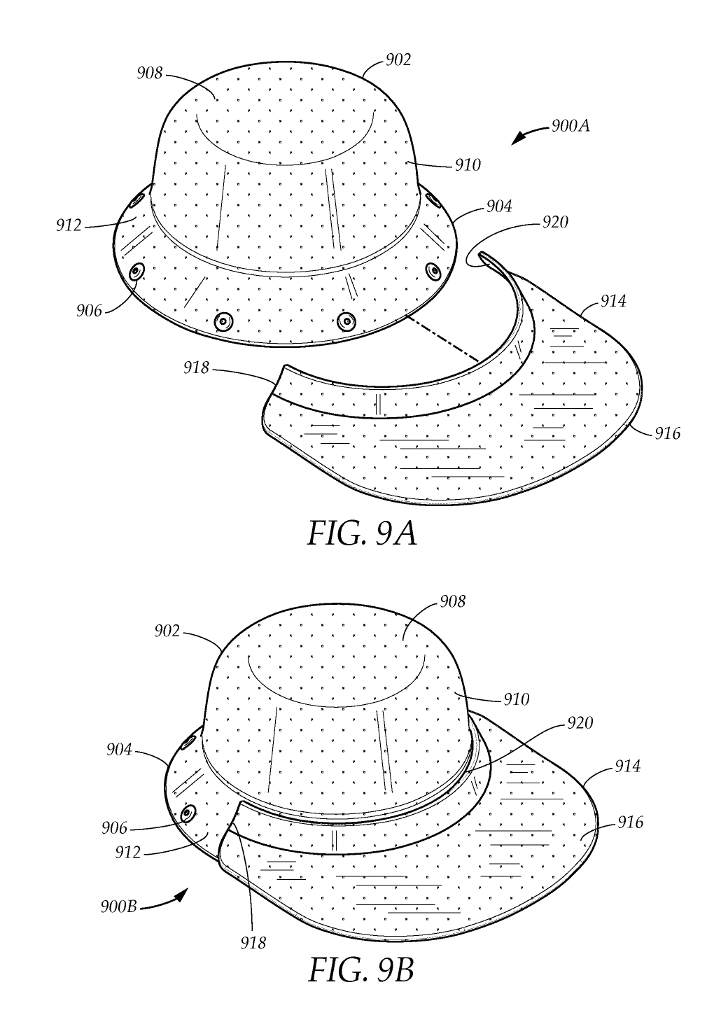

FIGS. 9A and 9B show an embodiment of a method of attaching a crown to a visor according to this disclosure. A hat 900 is shown in a first state 900A and a second state 900B. In the first state 900A, the hat 900 includes a crown 902 and a visor 916 in a detached form. In the second state 900B, the crown 902 and the visor 916 are in an attached form. For example, the crown 902 and the visor 916 can be removably attached.

The crown 902 is similar to the crown 100. The visor 916 is similar to the visor 300. The crown 902 includes a skirt 904, a plurality of snap fasteners 906, a bowl base 908, a bowl wall 910, and a side 912. The skirt 904 is similar to the skirt 104. The snap fasteners 906 are similar to the snap fasteners 106. The bowl base 908 is similar to the base 108. The bowl wall 910 is similar to the wall 110. The side 912 is similar to the wall 112. The visor 916 includes a side 914, a wall 918, and a plurality of snap fasteners 920. The side 914 is similar to the side 306. The wall 918 is similar to the wall 304. The snap fasteners 920 are similar to the snap fasteners 308. However, with respect to a snap fastener from at least one of the snap fasteners 906 or the snap fasteners 920, note that, whether additionally or alternatively, any other type of attachment technology can be used, such as mating, threading, adhering, magnetizing, interlocking, hook-and-looping, suctioning, or others.

The crown 902 is attached to the visor 916 via the snap fasteners 906 engaging with the snap fasteners 920 such that the wall 918 overlays or covers the side 912 of the skirt 904, whether contacting the side 912 or not, such as via a gap present therebetween. Likewise, the crown 902 is detached from the visor 916 via the snap fasteners 906 disengaging with the snap fasteners 920, such as via a user action.

In some embodiments, the strap 504 can be used with the hat 900, as shown in state 900B, similar to the hat 800. For example, the strap 504 can be extended about the wall 918, such as via contacting the wall 918 when the crown 902 is attached to the visor 916, and the crown 902, such as via contacting the side 912 or the bowl wall 910, and the pair of end portions 506 are tied about each other at least one time into a knot of any type. In some embodiments, a clip is used to secure the pair of end portions 506 together, such as when the clip contacts the crown 902 or the visor 916 in order to create a tight fit. In some embodiments, the strap 504 can be selectively tightened or untightened, such as via the pair of end portions 506, to adjust a fit to the head of the user, such as via controlling a degree or extent of pulling the strap 504. In some embodiments, the strap 504 covers a seam area formed when the crown 902 is attached to the visor 916, where the seam area is positioned between the crown 902 and the visor 916 and extending above the side 912. In some embodiments, the strap 504 can be secured to the crown 902 or the visor 916, such as via a magnet, a bolt, a nut, a button, an opening/slit, a zipper, a wire, a ribbon, a hook-and-loop fastener, a thread, a hook, a tape, a screw, a nail, a staple, an adhesive, a rubber band, a chain, a clip, or others, where at least one of the crown 902, the visor 916, or the strap 504 includes at least one such securing device. For example, the strap 504 can be tied in an adjustable loop such that the loop loops the crown 902 and the visor 916 as the strap 504 extends over the visor 916. For example, the strap 504 can attach to the visor 916 removably such that the strap 504 can adjust the visor 916 selectively.

In some embodiments, a hat design system is travel friendly, fashionable, collapsible, storable, compact, or sharable. The hat design system includes a brim of variety of lengths/widths/depths/thicknesses ranging from about 0.1 inches to about 20 inches, although variations, whether smaller or larger, are possible. The brim can be O-shaped, C-shaped, oval, visor, or baseball cap shaped. The brim can be configured for or not for a sun protection factor (SPF) use. The had design system includes a crown of a variety of types, such as cowboy, panama, porkpie, campaign, boater, stingy brim, fedora, visor, bowler hat, cadet cap, outdoor hat, pillbox, winter hat, cattleman, brick, gambler, pinched front, derby, gus, Amish, tom mix, open crown, beanie, baseball, boss of plains, bucket, cartwheel hat, cloche hat, homburg, mushroom hat, planter's hat, sailor hat, sun hat, top hat, or others. The hat design system includes various attachment interfaces, such as snaps, magnets, magnetic snaps, buttons, zippers, ribbons, covered wire, hook-and-loops, threading through with any ribbon or string hooks, tape, wire, clips. The hat design may include a variety of fabrics, whether configured for or not configured for SPF use, such as felt, straw, waterproof cotton, polyester, polyester blend, woven, non-woven, sun protectant, silk, satin, twill, stretch, jersey, cotton, braided, crotchet, wool, leather, faux leather, suede, faux suede, mesh, denim, jacquard, nylon, spandex, lace, velvet, crushed velvet, fleece, corduroy, knit, fur, faux fur, ribbon, lycra, waterproof, straw, crushable straw, plastic, fiber, terry cloth, canvas, grosgrain, braided cord, chlorine resistant, saltwater resistant, houndstooth, or others.

Features described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity in any manner.

In some embodiments, at least one of the crown 100, the brim 200, the visor 300, or the strap 504 includes at least one of a photovoltaic cell, a battery coupled to the photovoltaic cell for photovoltaic energy receipt, and a port configured to receive power from the battery or upload data. In some embodiments, at least one of the crown 100, the brim 200, the visor 300, or the strap 504 includes at least one of a processor, a memory coupled to the processor, a transceiver coupled to the processor, or a display coupled to the processor, which may be powered via the battery. The memory may store a code executable via the processor to implement a method employing the transceiver to communicate with a remote device wirelessly, over a short range or long range network, such as a mobile device or a network antenna, or employing the display to present information thereon, whether locally stored or obtained via the transceiver, such as a visual pattern.

Various terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

Various terminology used herein is for describing particular example embodiments and is not intended to be necessarily limiting of this disclosure. As used herein, various singular forms “a,” “an” and “the” are intended to include various plural forms as well, unless a context clearly indicates otherwise. Various terms “comprises,” “includes” and/or “comprising,” “including” when used in this specification, specify a presence of stated features, integers, steps, operations, elements, and/or components, but do not preclude the presence and/or addition of one or more other features, integers, steps, operations, elements, components, and/or groups thereof

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

Example embodiments of this disclosure are described herein with reference to illustrations of idealized embodiments (and intermediate structures) of this disclosure. As such, variations from various illustrated shapes as a result, for example, of manufacturing techniques and/or tolerances, are to be expected. Thus, various example embodiments of this disclosure should not be construed as necessarily limited to various particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing, and/or other any other types of manufacturing. For example, some manufacturing processes include three dimensional (3D) printing, laser cutting, computer numerical control routing, milling, pressing, stamping, vacuum forming, hydroforming, injection molding, lithography, and so forth.

Any and/or all elements, as disclosed herein, can be and/or include, whether partially and/or fully, a solid, including a metal, a mineral, an amorphous material, a ceramic, a glass ceramic, an organic solid, such as wood and/or a polymer, such as rubber, a composite material, a semiconductor, a nanomaterial, a biomaterial and/or any combinations thereof. Any and/or all elements, as disclosed herein, can be and/or include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, opaqueness, luminescence, reflection, phosphorescence, anti-reflection and/or holography, a photo-sensitive coating, an electronic and/or thermal property coating, such as for passivity, insulation, resistance or conduction, a magnetic coating, a water-resistant and/or waterproof coating, a scent coating and/or any combinations thereof. Any and/or all elements, as disclosed herein, can be rigid, flexible, and/or any other combinations thereof. Any and/or all elements, as disclosed herein, can be identical and/or different from each other in material, shape, size, color and/or any measurable dimension, such as length, width, height, depth, area, orientation, perimeter, volume, breadth, density, temperature, resistance, and so forth.

Unless otherwise defined, all terms (including technical and scientific terms) used herein have the same meaning as commonly understood by one of ordinary skill in an art to which this disclosure belongs. Various terms, such as those defined in commonly used dictionaries, should be interpreted as having a meaning that is consistent with a meaning in a context of a relevant art and should not be interpreted in an idealized and/or overly formal sense unless expressly so defined herein.

Furthermore, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

As used herein, a term “about” and/or “substantially” refers to a +/−10% variation from a nominal value/term. Such variation is always included in any given value/term provided herein, whether or not such variation is specifically referred thereto.

If any disclosures are incorporated herein by reference and such disclosures conflict in part and/or in whole with this disclosure, then to an extent of a conflict, if any, and/or a broader disclosure, and/or broader definition of terms, this disclosure controls. If such disclosures conflict in part and/or in whole with one another, then to an extent of a conflict, if any, a later-dated disclosure controls.

In some embodiments, various functions or acts can take place at a given location and/or in connection with the operation of one or more apparatuses or systems. In some embodiments, a portion of a given function or act can be performed at a first device or location, and a remainder of the function or act can be performed at one or more additional devices or locations.

The corresponding structures, materials, acts, and equivalents of all means or step plus function elements in the claims below are intended to include any structure, material, or act for performing the function in combination with other claimed elements as specifically claimed. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the steps can be performed in a differing order or steps can be added, deleted or modified. All of these variations are considered a part of the disclosure. It will be understood that those skilled in the art, both now and in the future, can make various improvements and enhancements which fall within the scope of the claims which follow.

The description of this disclosure has been presented for purposes of illustration and description, but is not intended to be fully exhaustive and/or limited to the disclosure in the form disclosed. Many modifications and variations in techniques and structures will be apparent to those of ordinary skill in an art without departing from a scope and spirit of this disclosure as set forth in the claims that follow. Accordingly, such modifications and variations are contemplated as being a part of this disclosure. A scope of this disclosure is defined by various claims, which include known equivalents and unforeseeable equivalents at a time of filing of this disclosure.

What is claimed is:

1. A method comprising:
removably attaching a crown to a C-shaped brim; and
tying a strap in an adjustable loop such that the loop loops the crown and the strap extends along the C-shaped brim.

2. The method of claim 1, wherein the C-shaped brim includes an inner edge portion extending over the crown, wherein the strap extends over the inner edge portion.

3. The method of claim 1, wherein the strap is not transparent.

4. The method of claim 1, wherein the C-shaped brim is not rigid.

5. The method of claim 1, wherein the strap is attached to the C-shaped brim, and further comprising:
selectively adjusting the C-shaped brim via the strap.

6. The method of claim 5, wherein the strap is removably attached to the C-shaped brim.

7. A method comprising:
removably attaching a crown to a visor; and
tying a strap in an adjustable loop such that the loop loops the crown and the strap extends over the visor.

8. A method comprising:
removably attaching a crown to a C-shaped brim;
attaching a strap to the C-shaped brim; and
selectively adjusting the C-shaped brim via the strap.

9. The method of claim 8, wherein the C-shaped brim includes an inner edge portion extending over the crown, wherein the strap extends over the inner edge portion.

10. The method of claim 8, wherein the strap is not transparent.

11. The method of claim 8, wherein the C-shaped brim is not rigid.

12. The method of claim 8, wherein the strap is removably attached to the C-shaped brim.

13. A kit comprising:
a crown;
a C-shaped brim configured for attachment to the crown in a first manner;
a visor configured for attachment to the crown in a second manner; and
a strap.

14. The kit of claim 13, wherein the first manner and the second manner are a same manner.

15. The kit of claim 13, wherein the first manner and the second manner are different manners.

16. The kit of claim 13, wherein the strap is configured for removable attachment to the C-shaped brim.

17. The kit of claim 16, wherein the strap is configured for selective adjustment of the C-shaped brim when attached thereto.

18. The kit of claim 13, wherein at least one of the crown, the brim, the visor, or the strap contains a photovoltaic cell.

19. The kit of claim 13, wherein at least one of the crown, the brim, the visor, or the strap contains a display configured to display a visual pattern.

20. The kit of claim 13, wherein at least one of the crown, the brim, the visor, or the strap contains a transceiver configured to communicate with an antenna.
